(19) United States
(12) Patent Application Publication
(10) Pub. No.: US 2010/0181377 A1
(43) Pub. Date: Jul. 22, 2010

(54) CARD READER WITH NEAR FIELD COMMUNICATION FUNCTION AND NEAR FIELD COMMUNICATION DEVICE THEREOF

(75) Inventors: Chang-Chih Chen, Hsinchu County (TW); Jen-Wei Lo, Hsinchu City (TW)

Correspondence Address: J C PATENTS, 4 VENTURE, SUITE 250, IRVINE, CA, 92618, US

(73) Assignee: PHISON ELECTRONICS CORP., Miaoli (TW)

(21) Appl. No.: 12/397,631

(22) Filed: Mar. 4, 2009

(30) Foreign Application Priority Data
Jan. 20, 2009 (TW) 98102039

(51) Int. Cl. G06K 7/01

(52) U.S. Cl. 235/440

(57) ABSTRACT

A card reader with a near field communication (NFC) function is provided. The card reader includes a connector for connecting a host, a radio frequency (RF) antenna, and a circuit board having a secure digital (SD) reader chip and a micro SD interface slot. The micro SD interface slot has two RF pads coupled to the RF antenna, and a micro SD memory card having a flash memory chip, a control circuit, and a smart card circuit is inserted into the micro SD interface slot in a detachable manner. Thereby, the host can access data in the flash memory chip through the SD reader chip and the micro SD interface slot, and the smart card circuit can perform a NFC through the RF antenna and the micro SD interface slot.

### CROSS-REFERENCE TO RELATED APPLICATION

This application claims the priority benefit of Taiwan application serial no. 98102039, filed on Jan. 20, 2009. The entirety of the above-mentioned patent application is hereby incorporated by reference herein and made a part of this specification.

### BACKGROUND OF THE INVENTION

1. Field of the Invention

The present invention relates to a card reader with a near field communication (NFC) function and a NFC device thereof, wherein a micro secure digital (SD) memory card having a smart card circuit can be connected to the card reader in a detachable manner.

2. Description of Related Art

Smart cards have been broadly used along with the widespread of e-wallet and prepayment applications. A smart card is an integrated circuit (IC) card embedded with such components as a microprocessor, a card operating system, a security module, and a memory and which allows a card holder to perform various predetermined operations. Besides the function of data storage, a smart card also offers calculation, encryption, bidirectional communication, and security functions such that data stored in the smart card can be protected. A subscriber identification module (SIM) card used in a GSM (Global System for Mobile Communications) cellular phone is one of the many applications of smart cards. Generally speaking, a smart card has very limited storage capacity due to the specification of the IC therein.

A memory card is a data storage equipment and which usually uses a NAND flash memory as its storage medium. A NAND flash memory is rewritable and erasable, and data stored in a NAND flash memory is retained even when no power is supplied to the NAND flash memory. In addition, thanks to the advancement of the fabrication techniques, a NAND flash memory also offers many other advantages, such as small volume, high access speed, and low power consumption, etc. Thus, in recent years, people in the industry have been trying to integrate smart card with large-capacity memory card in order to increase the storage capacity of smart card.

Generally speaking, a user can access data in a memory card through a card reader. Thus, in an application wherein a smart card is integrated with a memory card, data stored in the memory card and the smart card can only be read through a card reader in a contact manner. However, along with the development of near field communication (NFC), many contactless sensing techniques have been broadly applied in our daily life, such as transit fare cards and access cards, etc. Thereby, even though a smart card can be integrated with a memory card of large storage capacity, the application thereof is greatly restricted if contactless access cannot be accomplished.

### SUMMARY OF THE INVENTION

Accordingly, the present invention is directed to a card reader with a near field communication (NFC) function, wherein the card reader allows a memory card having a smart card circuit to perform a NFC.

The present invention is directed to a NFC device with a smart card function, wherein the NFC device has a removable memory card with a smart card function and which allows the memory card to perform a NFC.

The present invention provides a card reader with a NFC function. The card reader includes a connector for connecting a host, a radio frequency (RF) antenna, and a circuit board having a secure digital (SD) reader chip and a micro SD interface slot. The SD reader chip is coupled to the connector, and the micro SD interface slot has two first RF pads coupled to the RF antenna, wherein the micro SD interface slot is used for connecting a micro SD memory card in a detachable manner. The micro SD memory card includes a flash memory chip for storing data, a data process control chip coupled to the flash memory chip, and two second RF pads coupled to the data process control chip, wherein the two second RF pads are respectively coupled to the two first RF pads. In the card reader, the SD reader chip converts the data in the flash memory chip into a format compatible to the connector.

The present invention provides a NFC device with a smart card function. The NFC device includes a RF antenna, a micro SD interface slot, and a micro SD memory card. The micro SD interface slot has two first RF pads coupled to the RF antenna. The micro SD memory card is detachably connected to the micro SD interface slot and which includes a flash memory chip for storing data, a data process control chip coupled to the flash memory chip, and two second RF pads coupled to the data process control chip, wherein the two second RF pads are respectively coupled to the two first RF pads. In the NFC device, the RF antenna receives and transmits smart card secure data processed by a smart card circuit.

As described above, in the present invention, a memory card with a smart card circuit can both perform a NFC and provide a large storage space.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1(a)˜1(c) are diagrams illustrating the appearance of a card reader according to an exemplary embodiment of the present invention.

FIG. 2 is a schematic block diagram of the card reader in FIG. 1.

FIG. 3 is a diagram illustrating the appearance of a card reader according to another exemplary embodiment of the present invention.

FIGS. 4(a)˜4(c) are diagrams illustrating the appearance of a NFC (near field communication) device according to an exemplary embodiment of the present invention.

FIG. 5 is a schematic block diagram of the NFC device in FIG. 4.

### DESCRIPTION OF THE EXEMPLARY EMBODIMENTS

Reference will now be made in detail to the present exemplary embodiments of the invention, examples of which are illustrated in the accompanying drawings. Wherever possible, the same reference numbers are used in the drawings and the description to refer to the same or like parts.

### First Exemplary Embodiment

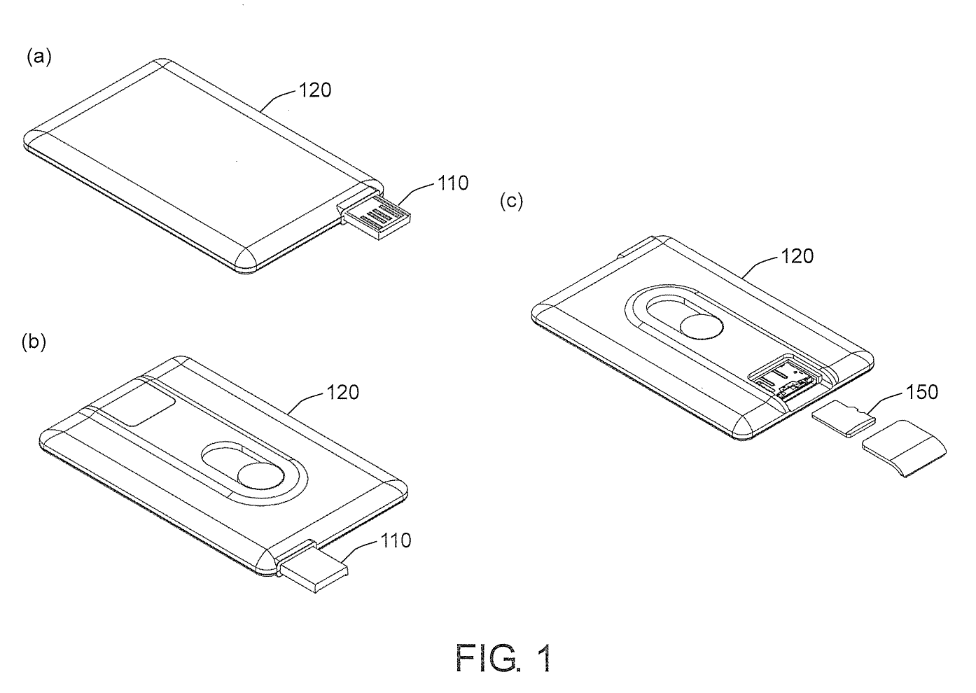

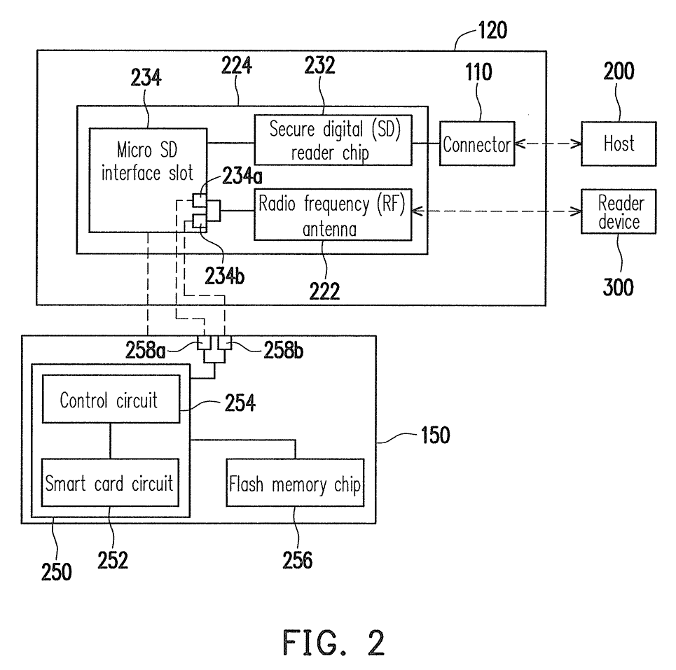

FIG. 1 is a diagram illustrating the appearance of a card reader according to an exemplary embodiment of the present invention, and FIG. 2 is a schematic block diagram of the card reader in FIG. 1.

Referring to both FIG. 1 and FIG. 2, the card reader includes a connector 110 and a carrier 120.

The connector 110 is used for connecting a host 200. In the present exemplary embodiment, the connector 110 is a universal serial bus (USB) connector. However, the present invention is not limited thereto, and in another exemplary embodiment of the present invention, the connector 110 may also be a PCI express connector, an IEEE 1394 connector, or other suitable connectors.

In the present exemplary embodiment, a radio frequency (RF) antenna 222 and a circuit board 224 are disposed in the carrier 120.

The RF antenna 222 receives and transmits RF signals to perform a near field communication (NFC) with a reader device 300 (for example, a RF reader). In the present exemplary embodiment, the RF antenna 222 is laid out on the circuit board 224. For example, the RF antenna 222 is directly printed on the circuit board 224 or formed by etching a metal layer disposed on the circuit board 224. However, the present invention is not limited thereto, and in another exemplary embodiment of the present invention, the RF antenna 222 may also be a device independent of the circuit board 224.

In the present exemplary embodiment, the circuit board 224 includes a secure digital (SD) reader chip 232 and a micro SD interface slot 234.

The SD reader chip 232 is coupled to the connector 110, and which recognizes a data format conforming to SD specification and converts the data format into a format recognizable to the host 200. To be specific, in the present exemplary embodiment, since the connector 110 is a USB connector, the SD reader chip 232 receives data and commands conforming to the USB specification from the host 200 and converts the data and commands into data and commands conforming to the SD specification, and the SD reader chip 232 also converts data and commands conforming to the SD specification into data and commands conforming to the USB specification and transmits the converted data and commands to the host 200.

The micro SD interface slot 234 is coupled to the SD reader chip 232 and which is used for connecting a micro SD memory card 150. To be specific, the micro SD memory card 150 is detachably inserted into the micro SD interface slot 234 so that the host 200 can access the micro SD memory card 150 through the SD reader chip 232.

Particularly, in an exemplary embodiment of the present invention, the micro SD interface slot 234 is coupled to the RF antenna 222 through two RF pads 234a and 234b. Accordingly, the micro SD memory card 150 connected to the micro SD interface slot 234 can receive and transmit commands and smart card secure data through the RF antenna 222.

The micro SD memory card 150 includes a data process control chip 250, a flash memory chip 256, and two RF pads 258a and 258b.

The data process control chip 250 controls the operation of the micro SD memory card 150 and which includes a smart card circuit 252 and a control circuit 254.

The smart card circuit 252 is coupled to the control circuit 254 and which encrypts, decrypts, processes, and stores smart card secure data of users. Generally speaking, because the smart card circuit 252 offers high data security, the smart card secure data processed by the smart card circuit 252 can be used in applications such as identity authentication and small amount payment. For example, the smart card secure data may be public transit ticket data or financial data, etc. In the present exemplary embodiment, an interface of the smart card circuit 252 conforms to an ISO 7816-3 standard and an ISO14443 standard. However, the present invention is not limited thereto, and the smart card circuit 252 may also adopt a higher level data security mechanism. It should be mentioned that the encryption or decryption method adopted by the smart card circuit 252 is conforming to the rivest shamir adleman (RSA) algorithm, the advanced encryption standard (AES), the data encryption standard (DES), and the triple data encryption standard (3DES).

The control circuit 254 is coupled to the flash memory chip 256 for controlling the flash memory chip 256.

In the present exemplary embodiment, a user can insert the micro SD memory card 150 into the card reader provided by the present exemplary embodiment to connect to the host 200 through the connector 110 and carry out a contact communication conforming to the ISO 7816-3 standard. For example, the user may insert the micro SD memory card 150 containing financial smart card secure data into the card reader provided by the present exemplary embodiment and make online payment through the host 200 and the Internet.

The flash memory chip 256 is controlled by the control circuit 254 to store data to be written by the host 200 according to a command of the host 200. To be specific, after a user inserts the micro SD memory card 150 into the micro SD interface slot 234, the host 200 issues an access command (for example, a write command or a read command, etc) to the control circuit 254 through the SD reader chip 232, and the control circuit 254 operates the flash memory chip 256 according to the received command to write a data received from the host 200 into the flash memory chip 256 or transmit a data from the flash memory chip 256 to the host 200.

For example, in the present exemplary embodiment, the control circuit 254 includes a microprocessor unit for controlling the operation of the micro SD memory card 150, a buffer for temporarily storing data, a flash memory interface module for accessing the flash memory chip 256, a micro SD interface module for communicating with the SD reader chip 232, an interface module for accessing the smart card circuit 252, and an error checking and correction module (not shown in the drawings), etc.

In the present exemplary embodiment, the microprocessor unit of the control circuit 254 determines whether the command and data received through the micro SD interface slot 234 are general command and data or smart card command and smart card secure data which have to be processed by the smart card circuit 252, and according to the determination result, the microprocessor unit writes the data into the flash memory chip 256 or transmits the command and data to the smart card circuit 252. In addition, as described above, in the present exemplary embodiment, with the limited storage capacity of the smart card circuit 252, the smart card secure data in the smart card circuit 252 can be stored into the large-capacity flash memory chip 256 under the control of the control circuit 254.

The RF pads 258a and 258b are coupled to the data process control chip 250, wherein the RF pad 258a is coupled to the RF pad 234a, and the RF pad 258b is coupled to the RF pad 234b.

For example, when the micro SD memory card 150 having the smart card circuit 252 is inserted into the micro SD interface slot 234, the smart card circuit 252 can be coupled to the RF antenna 222 through the RF pads 258a and 258b and the RF pads 234a and 234b of the micro SD interface slot 234 to communicate with the reader device 300, so as to receive and transmit smart card commands and smart card secure data.

In other words, the user may insert the micro SD memory card 150 into the card reader provided by the present exemplary embodiment to carry out a contactless NFC conforming to the ISO14443 standard. For example, the user may insert the micro SD memory card 150 containing smart card secure data of transit ticket into the card reader provided by the present exemplary embodiment to communicate with a reader device 300 deployed in a public transit station and make payment in a contactless manner, or the user may also insert the micro SD memory card 150 containing financial smart card secure data into the card reader provided by the present exemplary embodiment in a related store (for example, a petrol station or a convenience store) to communicate with a reader device 300 deployed in the store and make payment in a contactless manner.

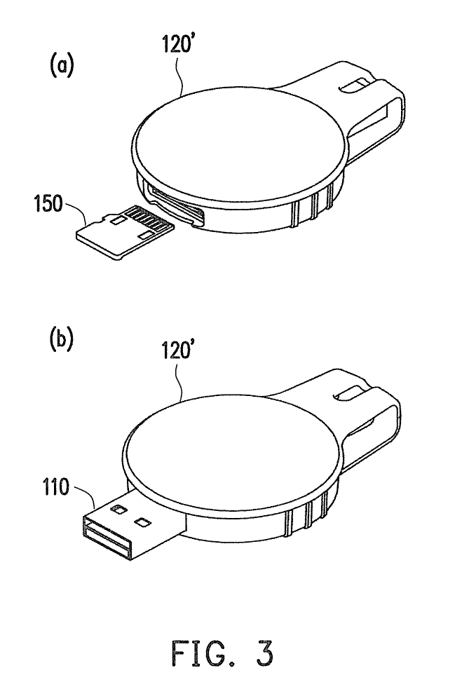

In the present exemplary embodiment, the carrier 120 is an ID-1 model conforming to the ISO 7810 standard. Namely, the length of the carrier 120 is 85.6 mm and the width thereof is 53.98 mm. However, the present invention is not limited thereto, and in another exemplary embodiment of the present invention, the carrier 120 may also be a ID-2 model, an ID-3 model, or other suitable model conforming to the ISO 7810 standard (for example, the carrier 120′ as shown in FIG. 3).

### Second Exemplary Embodiment

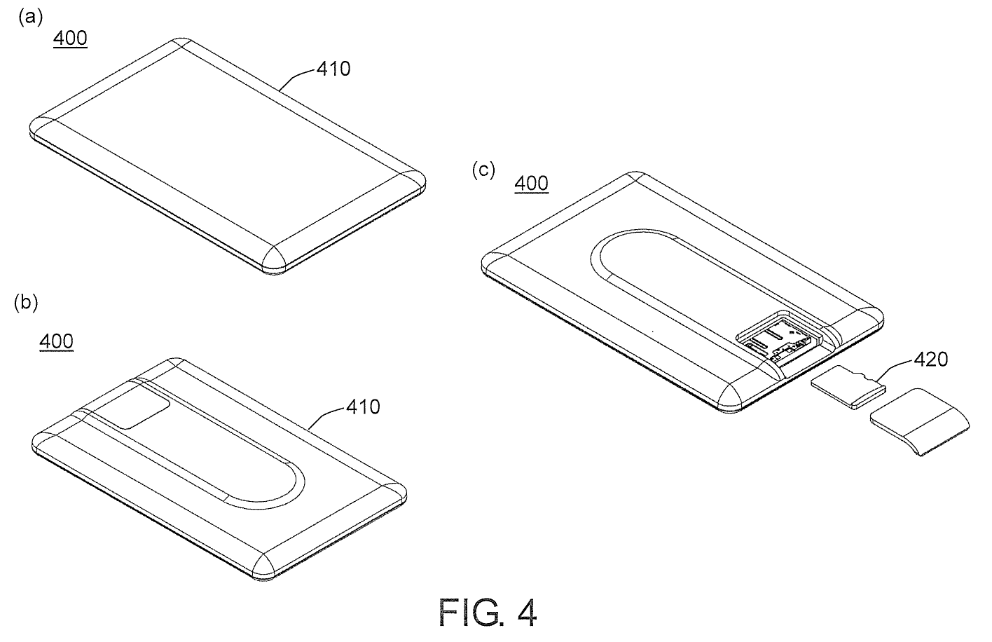

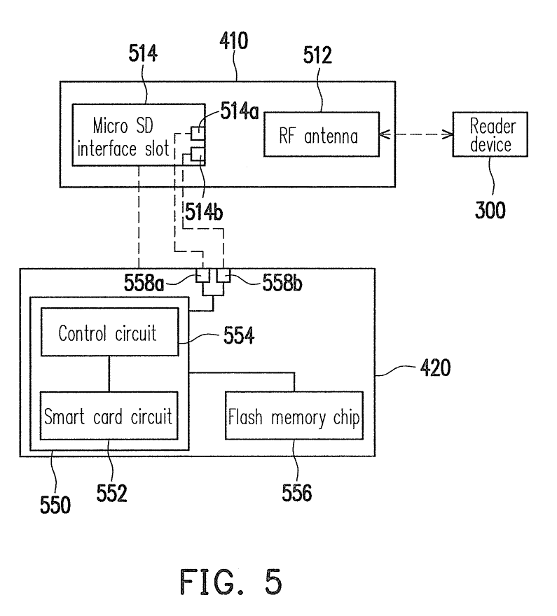

FIG. 4 is a diagram illustrating the appearance of a NFC device according to an exemplary embodiment of the present invention, and FIG. 5 is a schematic block diagram of the NFC device in FIG. 4.

Referring to both FIG. 4 and FIG. 5, the NFC device 400 includes a carrier 410 and a detachable micro SD memory card 420.

In the present exemplary embodiment, a RF antenna 512 and a micro SD interface slot 514 are disposed in the carrier 410.

The RF antenna 512 receives and transmits RF signals to perform a NFC with a reader device 300 (for example, a RF reader).

The micro SD interface slot 514 is used for connecting the micro SD memory card 420. To be specific, the micro SD memory card 420 is inserted into the micro SD interface slot 514 in a detachable manner. Particularly, in an exemplary embodiment of the present invention, the micro SD interface slot 514 is coupled to the RF antenna 512 through two RF pads 514a and 514b. Thus, the micro SD memory card 420 connected to the micro SD interface slot 514 can receive and transmit commands and smart card secure data through the RF antenna 512.

The micro SD memory card 420 includes a data process control chip 550, a flash memory chip 556, and two RF pads 558a and 558b.

The data process control chip 550 controls the operation of the micro SD memory card 420 and which includes a smart card circuit 552 and a control circuit 554.

The smart card circuit 552 is coupled to the control circuit 554 and which encrypts, decrypts, processes, and stores smart card secure data. Generally speaking, because the smart card circuit 552 offers high data security, the smart card secure data processed by the smart card circuit 552 can be used in applications such as identity authentication and small amount payment. For example, the smart card secure data may be public transit ticket data or financial data, etc. In the present exemplary embodiment, an interface of the smart card circuit 552 conforms to an ISO 7816-3 standard and an ISO14443 standard. However, the present invention is not limited thereto, and the smart card circuit 552 may also adopt other higher level data security mechanism.

The control circuit 554 is coupled to the flash memory chip 556 for controlling the flash memory chip 556.

The RF pads 558a and 558b are coupled to the data process control chip 550, wherein the RF pad 558a is coupled to the RF pad 514a, and the RF pad 558b is coupled to the RF pad 514b.

For example, when the micro SD memory card 420 having the smart card circuit 552 is inserted into the micro SD interface slot 514, the smart card circuit 552 is connected to the RF antenna 512 through the RF pads 558a and 558b and the RF pads 514a and 514b of the micro SD interface slot 514 to communicate with the reader device 300 and receive and transmit smart card commands and smart card secure data. In other words, the user may insert the micro SD memory card 420 into the NFC device 400 to perform a contactless NFC. For example, when the user takes a public transit, the user may insert micro SD memory card 420 containing smart card secure data of transit ticket into a NFC device 400 to make a payment in a contactless manner, or when the user shops in a related store, the user may insert the micro SD memory card 420 containing financial smart card secure data into a NFC device 400 deployed in the store to make a payment in a contactless manner.

The flash memory chip 556 is controlled by the control circuit 554 for storing data. Particularly, in the present exemplary embodiment, with the limited storage capacity of the smart card circuit 552, the smart card secure data in the smart card circuit 552 can be stored in the large-capacity flash memory chip 556 under the control of the control circuit 554.

For example, in the present exemplary embodiment, the control circuit 554 includes a microprocessor unit for controlling the operation of the micro SD memory card 420, a buffer for temporarily storing data, a flash memory interface module for accessing the flash memory chip 556, and an error checking and correction module (not shown in the drawings).

In the present exemplary embodiment, the carrier 410 is an ID-1 model conforming to the ISO 7810 standard. Namely, the length of the carrier 410 is 85.6 mm and the width thereof is 53.98 mm. However, the present invention is not limited thereto, and in another exemplary embodiment of the present invention, the carrier 410 may also be an ID-2 model, an ID-3 model, or other suitable model conforming to the ISO 7810 standard.

As described above, in the present invention, a RF antenna is laid out in a card reader through the RF pads of a micro SD interface slot so that a micro SD memory card having a smart card circuit can perform a NFC through the card reader and accordingly can make a contactless payment. Moreover, the card reader of ID-1 model conforming to the ISO 7810 standard also serves as a large-capacity portable storage device through a connector connected to a host. Furthermore, because the smart card circuit is laid out on the micro SD memory card, a user needs not to carry many smart cards. Instead, the user can make the contactless payment by simply inserting a micro SD memory card into a NFC device provided by the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A card reader with a near field communication (NFC) function, comprising:
a connector, for connecting a host;
a radio frequency (RF) antenna; and
a circuit board, having a secure digital (SD) reader chip and a micro SD interface slot, wherein the SD reader chip is coupled to the connector, the micro SD interface slot has two first RF pads coupled to the RF antenna, and the micro SD interface slot is used for connecting a micro SD memory card in a detachable manner, the micro SD memory card comprising:
a flash memory chip;
a data process control chip, coupled to the flash memory chip; and
two second RF pads, coupled to the data process control chip,
wherein the two second RF pads are respectively coupled to the two first RF pads,
wherein the SD reader chip receives data from the micro SD memory card through the micro SD interface slot and converts the data into a format compatible to the connector.

2. The card reader according to claim 1, wherein the data process control chip comprises:
a control circuit, coupled to the flash memory chip, for controlling the flash memory chip; and
a smart card circuit, coupled to the control circuit, for encrypting, decrypting and storing smart card secure data,
wherein the smart card circuit receives the smart card secure data from the host or transmits the processed smart card secure data to the host through the control circuit.

3. The card reader according to claim 2, wherein the RF antenna receives and transmits the smart card secure data processed by the smart card circuit.

4. The card reader according to claim 1, wherein the connector is a universal serial bus (USB) connector.

5. The card reader according to claim 2, wherein an interface of the smart card circuit conforms to an ISO 7816-3 standard and an ISO14443 standard.

6. The card reader according to claim 1 further comprising a carrier for accommodating the RF antenna and the circuit board.

7. The card reader according to claim 6, wherein the carrier is an ID-1 model conforming to an ISO 7810 standard.

8. The card reader according to claim 1, wherein the RF antenna is laid out on the circuit board.

9. The card reader according to claim 1, wherein the flash memory chip further stores the smart card secure data.

10. A NFC device with a smart card function, comprising:
a RF antenna;
a micro SD interface slot, having two first RF pads coupled to the RF antenna; and
a micro SD memory card, detachably connected to the micro SD interface slot, the micro SD memory card comprising:
a flash memory chip;
a data process control chip, coupled to the flash memory chip; and
two second RF pads, coupled to the data process control chip,
wherein the two second RF pads are respectively coupled to the two first RF pads,
wherein the RF antenna receives and transmits smart card secure data processed by the data process control chip.

11. The NFC device according to claim 10, wherein the data process control chip comprises:
a control circuit, coupled to the flash memory chip, for controlling the flash memory chip; and
a smart card circuit, coupled to the control circuit, for encrypting, decrypting and storing the smart card secure data.

12. The NFC device according to claim 11, wherein an interface of the smart card circuit conforms to an ISO 7816-3 standard and an ISO14443 standard.

13. The NFC device according to claim 10 further comprising a carrier for accommodating the RF antenna, the micro SD interface slot, and the micro SD memory card.

14. The NFC device according to claim 13, wherein the carrier is an ID-1 model conforming to an ISO 7810 standard.

15. The NFC device according to claim 10, wherein the flash memory chip further stores the smart card secure data.
